(19) United States
(12) Patent Application Publication
(10) Pub. No.: US 2014/0212080 A1
(43) Pub. Date: Jul. 31, 2014

(54) COMPONENT FOR USE IN A BEARING DEVICE AND A METHOD FOR FORMING A LUBRICANT LAYER

(71) Applicants: Samsung Electro-Mechanics Japan Advanced Technology Co., Ltd., Shizuoka (JP); BALBIS Co., LTD, Hyogo (JP); University of Yamanashi, Yamanashi (JP)

(72) Inventors: Mitsuo KODAMA, Shizuoka (JP); Yuichiro HARAMOTO, Yamanashi (JP); Hiroyuki ANZAI, Hyogo (JP)

(73) Assignees: Samsung Electro-Mechanics Japan Advanced Technolog Co., Ltd., Shizuoka (JP); BALBIS Co., LTD, Hyogo (JP); University of Yamanashi, Yamanashi (JP)

(21) Appl. No.: 14/157,713

(22) Filed: Jan. 17, 2014

(30) Foreign Application Priority Data
Jan. 25, 2013 (JP) 2013-012639

(51) Int. Cl. F16C 32/06; C10M 105/70

(52) U.S. Cl. CPC F16C 32/06; C10M 105/70
USPC 384/114; 384/123; 508/100

(57) ABSTRACT

A component for use in a bearing device according to one embodiment of the present invention includes a lubricant layer on a surface of the component. Here, the lubricant layer contains a rod-like ionic liquid crystal compound having a cation group and an anion group.

### BACKGROUND OF THE INVENTION

1. Field of the Invention

The present invention relates to a component for use in a bearing device and a method for forming a lubricant layer for this component.

2. Description of the Related Art

Many of rotating apparatuses represented by disk drive devices such as hard disk drives are each equipped with a bearing unit (bearing device) that rotatably supports a hub having recording disks fit thereon (see Japanese Unexamined Patent Application Publication No. 2012-87867, for instance).

A lengthened life is constantly required of the aforementioned rotating apparatuses. Accordingly, the long durability is also constantly required of the bearing device installed in the rotating apparatus. Through their earnest and diligent research-and-development efforts under these circumstances, the inventors of the present invention have come to recognize the following problems to be resolved.

That is, the bearing device includes, for example, a shaft body and a bearing body that rotatably contains the shaft body. Or alternatively, the bearing device includes, for example, a rotating body and a static body having a static body surface disposed counter to a rotary body surface of the rotating body. During a normal rotation, the shaft body and the bearing body or the rotating body and the static body are rotated in noncontact condition. However, there are cases where they rotate mutually in contact with each other during a low-speed rotation such as at the start of rotation or at deceleration. Where they rotate relative to each other and in contact with each other, their parts mutually coming into contact are worn away and therefore foreign substances such as abrasion powders may possibly be produced there.

While an equipment in which the bearing device is installed is being carried or when this equipment is accidentally dropped, the bearing device may be subjected to a tremendous shock. When the bearing device suffers such a shock, the shaft body and the bearing body or the rotating body and the static body may collide with each other so as to be damaged and therefore broken pieces resulting from the damage may possibly become unwanted foreign materials. If such foreign material enters into a gap between the shaft body and the bearing body or between the rotating body and the static body, this may hinder the normal operation of the bearing device and may cause the bearing device to malfunction. Thus the conventional bearing devices still have room for improvement toward the prolonged durability of the bearing device.

### SUMMARY OF THE INVENTION

The present invention has been made under the foregoing circumstances, and a purpose thereof is to provide a technology for making the bearing device durable for a very long period of time.

One embodiment of the present invention relates to a component for use in a bearing device. The component for use in a bearing device includes a lubricant layer on a surface of the component. Here, the lubricant layer contains a rod-like ionic liquid crystal compound having a cation group and an anion group.

Another embodiment of the present invention relates to a method for forming a lubricant layer. The method for forming the lubricant layer includes: applying a lubricant-layer-forming composition containing the rod-like ionic liquid crystal compound having the cation group and the anion group, to the surface of a component for use in a bearing device; and heating the lubricant-layer-forming composition applied to the surface thereof.

Optional combinations of the aforementioned constituting elements, and implementations of the invention in the form of methods, apparatuses, systems, and so forth may also be practiced as additional modes of the present invention.

### BRIEF DESCRIPTION OF THE DRAWINGS

Embodiments will now be described by way of examples only, with reference to the accompanying drawings which are meant to be exemplary, not limiting and wherein like elements are numbered alike in several Figures in which:

FIG. 1A is a plane view showing a general structure of a rotating apparatus equipped with a component, for use in a bearing device, according to an embodiment;

FIG. 1B is a side view showing a general structure of a rotating apparatus;

FIG. 1C is a plane view of a rotating apparatus with a top cover removed;

FIG. 2 is a cross-sectional view taken along the line A-A of FIG. 1C;

FIG. 3 is a plane view showing a general structure of a laminated core;

FIG. 4 is a cross-sectional view showing a general structure of a component, for use in a bearing device, near a lubricant layer;

FIG. 5 is an enlarged schematic illustration of a part of a lubricant layer; and

FIG. 6 is an enlarged schematic illustration of a part of a lubricant layer having a structure of stacked rod-like ionic liquid crystal compounds.

### DETAILED DESCRIPTION OF THE INVENTION

The invention will now be described by reference to the preferred embodiments. This does not intend to limit the scope of the present invention, but to exemplify the invention.

Hereinafter, the present invention will be described based on preferred embodiments with reference to the accompanying drawings. The same or equivalent constituents or members illustrated in each drawing will be denoted with the same reference numerals, and the repeated description thereof will be omitted as appropriate. The dimensions of the members in each drawing are illustrated by appropriately scaling the actual sizes thereof for ease of understanding. Some of the components and members in each Figure may be omitted if they are not important in the course of explanation. The preferred embodiments do not intend to limit the scope of the invention but exemplify the invention. All of the features and the combinations thereof described in the embodiments are not necessarily essential to the invention.

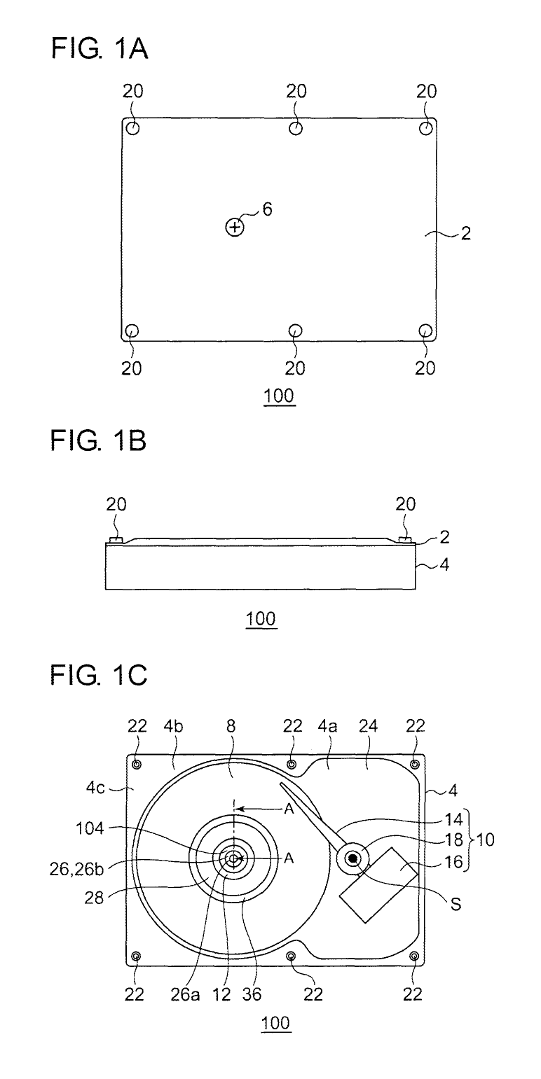

FIG. 1A is a plane view showing a general structure of a rotating apparatus equipped with a component, for use in a bearing device, according to an embodiment. FIG. 1B is a side view showing a general structure of the rotating apparatus. FIG. 10 is a plane view of the rotating apparatus with a top cover removed. A rotating apparatus 100 includes a fixed portion (stationary portion), a rotating portion relative to the fixed portion, a magnetic recording disk 8 mounted on the rotating portion, and a data read/write unit 10. The fixed portion includes a base 4, a shaft 26 secured to the base 4, a top cover 2, six screws 20, a shaft securing screw 6 and so forth. The rotating portion includes a hub 28, a clamper 36, and so forth. In the following description, a side where the hub 28 is mounted relative to the base 4 is defined as “upside” of the rotating apparatus 100.

The magnetic recording disk 8 is a 2.5-inch type magnetic recording disk made of glass, for instance, and the diameter thereof is 65 mm, for instance. Also, the diameter of a hole provided in a center of the magnetic recording disk 8 is 20 mm, and the thickness thereof is 0.65 mm. A single piece of magnetic recording disk 8 is placed and held on the hub 28. The base 4 is formed such that an aluminum alloy is molded using a die-cast. The base 4 has a bottom plate 4a, which forms a base portion of the rotating apparatus 100, and an outer peripheral wall 4b, which is formed along the outer periphery of the bottom plate 4a in such a manner as to surround a placement region of the magnetic recording disk 8. A top face 4c of the outer peripheral wall 4b has six screw holes 22.

The data read/write unit 10 is constituted by a read/write head (not shown), a swing arm 14, a voice coil motor 16, and a pivot assembly 18. The read/write head, which is mounted on a tip of the swing arm 14, records data to the magnetic recording disk 8 and reads data from the magnetic recording disk 8. The pivot assembly 18 swingably supports the swing arm 14 relative to the base 4 around the head rotating axis S. The voice coil motor 16 causes the swing arm 14 to swing about the head rotating axis S and thereby moves the read/write head to a predetermined position on a top face of the magnetic recording disk 8. The voice coil motor 16 and the pivot assembly 18 may be configured by the use of any known technique for controlling the position of the head.

The top cover 2 is fixed to the top face 4c of the outer peripheral wall 4b in the base 4 by means of the six screws 20. The six screws 20 correspond respectively to the six screw holes 22. In particular, the top cover 2 and the top face 4c of the outer peripheral wall 4b are mutually secured to each other in order not to allow the outside air and the like to leak into the interior of the rotating apparatus 100 through a joint portion between the top cover 2 and the top face 4c of the outer peripheral wall 4b. Here, the interior of the rotating apparatus 100 is specifically a clean space 24 surrounded by the bottom plate 4a of the base 4, the outer peripheral wall 4b of the base 4 and the top cover 2. The clean space 24 is hermetically sealed, that is, the clean space 24 is designed in such a manner that does not allow the outside air and the like from the outside to leak thereinto and does not allow air or gas inside the clean space 24 to leak out to the exterior. The clean space 24 is filled with the cleaned air in which particles have been removed. This prevents foreign substances, such as the particles, from adhering to the magnetic recording disk 8 and therefore the reliability of operation of the rotating apparatus 100 is enhanced.

The shaft 26 extends in a direction that intersects with an extending direction of the base 4. A shaft securing screw hole 26a is formed in an upper end surface 26b of the shaft 26. An underside of the shaft 26 is fixed to the base 4 as will be described later. The shaft securing screw 6 penetrates the top cover 2 and is screwed into the shaft securing screw hole 26a. Thereby, an upper end of the shaft 26 is secured to the top cover 2 and the base 4.

The shaft 26 is formed of steel material such as quenched SUS420J2. The shaft 26 undergoes a quenching processing. This allows the hardness of the shaft securing screw hole 26a in particular to be higher than that of the shaft securing screw 6 screwed thereinto. Hence, the engagement of the shaft securing screw 6 with the shaft securing screw hole 26a can reduce the possibility that a thread groove provided in the shaft securing screw hole 26a will be deformed.

If used among rotating apparatuses of shaft secured type is such a rotating apparatus as described above where the both ends of the shaft 26 are secured to a chassis like the base 4 and the top cover 2, the shock resistance and the vibration resistance of the rotating apparatus as used herein can be improved. Where a fluid dynamic bearing is used in this type of rotating apparatus, a lubricant generally has two gas-liquid interfaces.

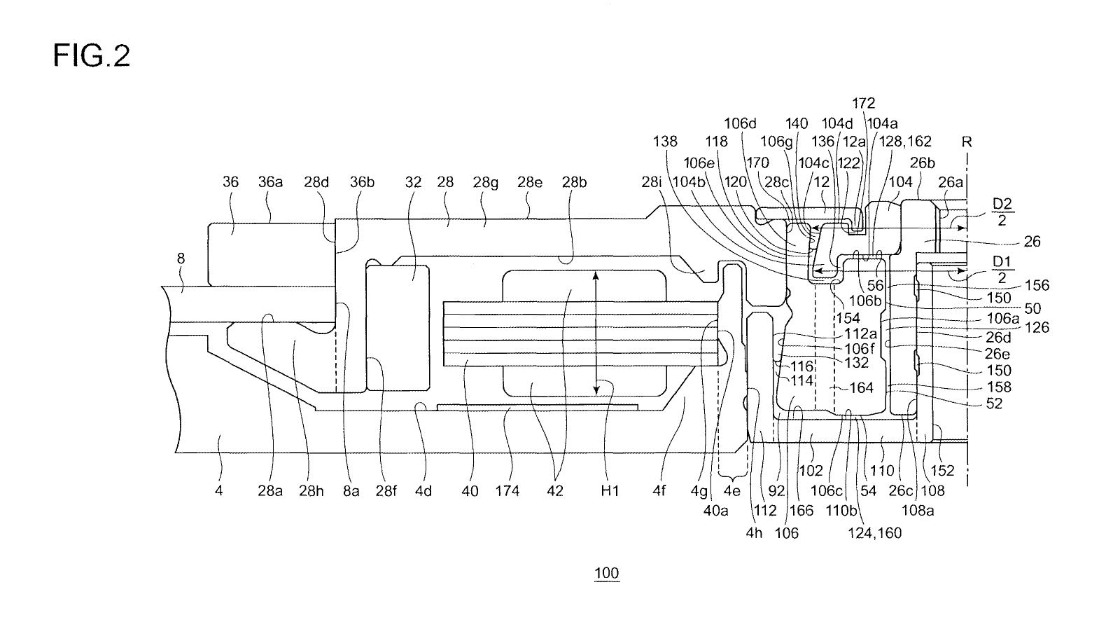

FIG. 2 is a cross-sectional view taken along the line A-A of FIG. 1C. The rotating portion includes a hub 28, a clamper 36, a cylindrical magnet 32, a sleeve 106, and a cover ring 12. The fixed portion includes a base 4, a laminated core 40, a coil 42, a housing 102, a shaft 26, and a ring portion 104. A lubricant 92 is continuously present in a part of a gap between the rotating portion and the fixed portion. When the rotating apparatus 100 is to be manufactured, first manufactured is a fluid dynamic pressure bearing unit including the housing 102, the sleeve 106, the ring portion 104, the lubricant 92 and the shaft 92. Then the hub 28, the base 4, the cover ring 12 and so forth are mounted on the fluid dynamic pressure bearing unit so as to manufacture the rotating apparatus 100. The base 4 rotatably supports the hub 28 by way of the fluid dynamic pressure bearing unit.

The hub 28 is formed such that a soft-magnetic steel material such as SUS430 undergoes cutting work or press work. Also, the hub 28 is formed in a predetermined shape of an approximate cup. The steel material used for the hub 28 may preferably be, for example, DHS1 that is a product name of stainless supplied by Daido Steel Co., Ltd. This is because DHS1 stainless is low outgassing and easily processed. In addition to being low outgassing and easily processed, DHS2 stainless, which is another product supplied from Daido Steel Co., Ltd., is more preferable in that DHS2 excels in corrosion resistance. The hub 28 has a hub protrusion 28g, which is fitted into a central hole 8a of the magnetic recording disk 8, and a placement section 28h, which is provided in a radially outward direction of the hub 28 and also further radially outward from the hub protrusion 28g. The hub protrusion 28g has a sleeve hole 28c with a rotating axis R of the hub 28 or the magnetic recording disk 8 as a center. The magnetic recording disk 8 is placed on a disk placing surface 28a, which is a top face of the placement section 28h.

The clamper 36 is engaged with an outer circumferential surface 28d of the hub protrusion 28g. The magnetic recording disk 8 is held between the clamper 36 and the placement section 28h and thereby the magnetic recording disk 8 is secured to the hub 28. As a result, the rotating apparatus 100 can be made thinner at least by the thickness of the clamper 36 as compared with a conventional configuration where the clamper 36 and the like are secured to a top face 28e of the hub 28. Also, a flexure or deformation of the hub 28 itself can be suppressed. The clamper 36 applies a downward force on a top face of the magnetic recording disk 8 and brings the magnetic recording disk 8 into contact with the disk placing surface 28a by pressuring. The clamper 36 and the outer circumferential surface 28d of the hub protrusion 28g are coupled with each other by a mechanical coupling means, such as the threadably mounting (screwing), caulking or press fitting, and a magnetic coupling means using a magnetic attraction. The clamper 36 is formed such that a top face 36a of the clamper 36 does not protrude beyond and above the top face 28e of the hub protrusion 28g while a predetermined downward force is being applied to the magnetic recording disk 8.

If, for example, the clamper 36 and the outer circumferential surface 28d of the hub protrusion 28g are screwed with each other, a male screw will be formed in the outer circumferential surface 28d of the hub protrusion 28g and a female screw corresponding to the male screw will be formed in an inner circumferential surface 36b of the clamper 36. In this case, the intensity of the downward force that the clamper 36 will apply to the top face of the magnetic recording disk 8 cab be relatively accurately controlled by adjusting the screwing amounts of the clamper 36.

The cylindrical magnet 32 is bonded to a cylindrical inner circumferential surface 28f, which corresponds to a cylindrical surface inside the hub 28 having an approximately cup-like shape. The cylindrical magnet 32, which is formed of a rare-earth material such as neodymium, iron or boron, is radially opposed to nine salient poles of the laminated core 40; that is, the cylindrical magnet 32 is opposed thereto in a direction intersecting perpendicularly with the rotating axis R. The cylindrical magnet 32 is magnetized to drive eight poles circumferentially, namely, in a tangential direction of a circle perpendicular to the rotating axis R with the rotating axis R as a center. A rust prevention process such as electro-deposition or spray coating is applied to the surface of the cylindrical magnet 32.

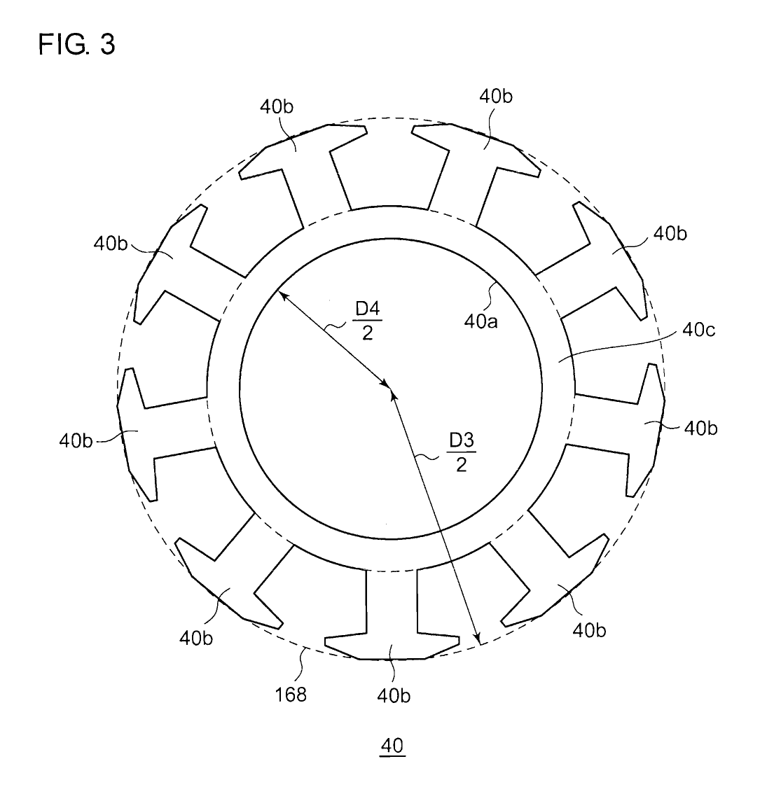

FIG. 3 is a plane view showing a general structure of a laminated core 40. The laminated core 40 has a circular part 40c and nine salient poles 40b extending from the circular part 40c in a radially outward direction. And the laminated core 40 is fixed on a top face 4d (see FIG. 2) side of the base 4. The laminated core 40 is formed such that five thin electromagnetic steel sheet are stacked together and integrally formed into a single unit by caulking. An insulation coating using electro-deposition, powder coating or the like is applied on the surface of the laminated core 40. The coil 42 is wound around each of the salient poles 40b of the laminated core 40. A three-phase drive current of an approximately sinusoidal waveform flows through the coil 42 so as to generate a drive magnetic flux along the salient pole 40b. The laminated core 40 and the coil 42 are formed such that the ratio of a height H1 over a difference (D3−D4) is in a range of 0.2 to 0.3. Here, D3 is a maximum outside diameter of the laminated core 40, namely, the diameter of a circle 168 circumscribing the nine salient poles 40b, and D4 is a minimum inside diameter of the laminated core 40, namely, the inside diameter of the circular part 40c. And H1 (see FIG. 2) is the height of the coil 42. For example, the height H1 of the coil 42 may be 2.22 mm, the difference (D3−D4) may be 8.67, and the ratio H1/(D3−D4) may be 0.256. Making the salient pole 40b relatively long in this manner restricts the height of H1 of the coil 42, thereby contributing to a reduction in thickness of the rotating apparatus.

As shown in FIG. 2, the base 4 has a cylindrical base protrusion 4e with the rotating axis R of the rotating portion as the center. The base protrusion 4e protrudes on a hub 28 side in such a manner as to circularly surround the housing 102. The laminated core 40 is secured to the base 4 such that a central hole 40a of the circular part 40c in the laminated core 40 is fitted to an outer circumferential surface 4g of the base protrusion 4e. In particular, the circular part 40c of the laminated core 40 is bonded such that the circular part 40c thereof is press-fitted or clearance-fitted to the base protrusion 4e. The base 4 has a shoulder portion 4f that is formed such that the shoulder portion 4f is located further radially outside the base 4 than the base protrusion 4e. The shoulder portion 4f has a shape corresponding to the outside diameter of the coil 42. An insulation sheet or tape 174 made of plastics such as PET (polyethylene terephthalate) or the like is provided in a part of the top face 4d of the base 4 corresponding to the salient poles 40b and the coil 42, namely, in a part thereof overlapping with at least part of the salient poles 40b and the coil 42 as viewed from a direction parallel to the rotating axis R.

The housing 102 includes a housing base 110, which is flat and circular, a cylindrical base-side encircling member 112, which is secured outside the housing base 110, a cylindrical support protrusion 108, which is secured inside the housing base 110. The housing 102 supports the shaft 26. Also, a circular support recess 166, into which a lower end of the sleeve 106 together with the shaft 26 to enter, is formed in the housing 102.

The housing base 110 and the base-side encircling member 112 are joined together such that the entire outer circumferential surface of the housing base 110 is located adjacent to a lower part of an inner circumferential surface 112a of the base-side encircling member 112. In the present embodiment, the housing base 110 and the base-side encircling member 112 are formed integrally with each other. The housing base 110 and the support protrusion 108 are joined together such that the entire inner circumferential surface of the housing base 110 is located adjacent to a lower part of an outer circumferential surface 108a of the support protrusion 108. In the present embodiment, the housing base 110 and the support protrusion 108 are formed integrally with each other. Forming the housing base 110 integrally with the base-side encircling member 112 and the support protrusion 108 reduces the manufacturing error of the housing 102 and avoids the trouble of having to otherwise connect each component. Also, if each of such components is provided as a separate part or body, the joint portion of each component needs to be relatively larger in size for the purpose of fixing each component with sufficiently high fixing strength. This is disadvantageous in terms of making the rotating apparatus 100 thinner. If, in contrast, each component is formed integrally as in the present embodiment, the thinning of the rotating apparatus 100 can be achieved. The base-side encircling member 112 is circularly surrounded by the base protrusion 4e. In particular, the base-side encircling member 112 is fixed by bonding to a bearing hole 4h provided in the base 4 with the rotating axis R as the center.

A support hole 26d is formed axially in the a lower end surface 26c of the shaft 26. The support hole 26d communicates with the shaft securing screw hole 26a provided in the upper end surface 26b of the shaft 26. In other words, the shaft 26 has a hollow shape. The support protrusion 108 is inserted into the support hole 26d and then secured. The support protrusion 108 is secured by simultaneously using the press-fitting and bonding. In particular, a joint portion of the outer circumferential surface 108a of the support protrusion 108 and a peripheral surface of the support hole 26d has two adhesive sumps 150, which are mutually spaced apart axially from each other. Each of the adhesive sumps 150 holds an adhesive therein. In a part of said joint portion thereof excluding the adhesive sumps 150, the outer circumferential surface 108a of the support protrusion 108 and a peripheral surface of the support hole 26d are basically pressed onto each other.

When the support protrusion 108 is secured by inserting the support protrusion 108 into the support hole 26d of the shaft 26, the shaft 26 and the support protrusion 108 are temporarily attached by the pressurized portions coming into contact, before the adhesives held in the adhesive sumps 150 have hardened. While the shaft 26 and the support protrusion 108 are being temporarily attached, the adhesives held in the adhesive sumps 150 harden and thereby a necessary fixing strength is obtained. In this case, the perpendicularity of the shaft 26 can be improved as compared with a case where the required fixing strength is to be obtained by the press-fitting alone, for instance. Also, the shaft 26 and the support protrusion 108 are separated parts, so that the shape of the components can be simplified and the deterioration of accuracy in forming each component can be minimized, as compared with a case where the shaft 26 and the support protrusion 108 are formed integrally into a single unit. Also, a peripheral surface of the shaft 26 can be formed with high dimensional accuracy while the shaft 26 is being secured to the base 4.

The support protrusion 108 is formed in such a manner as to have the same coefficient of linear expansion as that of the shaft 26. In particular, the housing 102 is formed of a material, such as SUS430 or DHS1, having practically the same coefficient of linear expansion as that of the material constituting the shaft 26. Thus, any adverse effect of the shaft 26 on the perpendicularity that may be caused by changes in temperature can be reduced. A through-hole 152 is provided in the support protrusion 108 along the rotating axis R. Note that the support protrusion 108 may have no through-hole 152 at all and note also that the support protrusion 108 may have a screw hole, with which the shaft securing screw 6 is screwed, instead of the through-hole 152.

The ring portion 104 circularly surrounds an upper-end side of the shaft 26 and is secured to the shaft 26. For example, the ring portion 104 is secured to the shaft 26 by simultaneously using the press-fitting and bonding. When the total fixing strength of the ring portion 104 and the shaft 26 is 30 kilograms, about 10 kilograms out of the total 30 kilograms accounts for the fixing strength of the bonding. The adhesive applied between the ring portion 104 and the shaft 26, which serves to seal off a gap between the ring portion 104 and the shaft 26, also functions as a sealing member by which to prevent the lubricant 92 from being leaked out. The ring portion 104 is formed of SUS430.

The sleeve 106 circularly surrounds a part of the shaft 26 joined (connected) to the support protrusion 108 (this part of the shaft 26 jointed thereto is hereinafter referred to as “joint portion” or “connected portion” as appropriate). The lubricant 92 is present in between the sleeve 106 and the connected portion of the shaft 26. That is, an inner circumferential surface 106a of the sleeve 106 and an outer circumferential surface 26e of the connected portion are face each other with a first gap 126 provided therebetween, and the first gap 126 is filled with the lubricant 92. The sleeve 106 is interposed, between the ring portion 104 and the housing 102, in a shaft direction of the rotating axis R. The lubricants 92 are present in between the sleeve 106 and the ring portion 104 and in between the sleeve 106 and the housing 102, respectively. That is, a top face 106b of the sleeve 106 faces an underside 104a of the ring portion 104 with a second gap 128 provided therebetween, and the second gap 128 is filled with the lubricant 92. Also, an underside 106c of the sleeve 106 faces a top face 110b of the housing base 110 with a third gap 124 provided therebetween, and the third gap 124 is filled with the lubricant 92. The hub 28 is secured to an outer circumferential surface 106e of an upper part 106d of the sleeve 106 by simultaneously using the press-fitting and bonding.

A lower part of the sleeve 106 is circularly surrounded by the base-side encircling member 112. A first taper seal 114 is formed between the base-side encircling member 112 and the sleeve 106. The first taper seal 114 is constituted by a fourth gap 132 provided between the inner circumferential surface 112a of the base-side encircling member 112 and an outer circumferential surface 106f of the lower part of the sleeve 106, and the first taper seal 114 has a shape such that the size thereof gradually increases in an upward direction toward an upper side thereof. In particular, the inner circumferential surface 112a of the base-side encircling member 112 is so formed as to be in approximately parallel with the rotation axis R, and the outer circumferential surface 106f of the lower part of the sleeve 106 is formed such that the diameter thereof is reduced upwardly. This achieves a tapered shape of the first taper seal 114. The first taper seal 114 has a first gas-liquid interface 116 of the lubricant 92 and prevents the lubricant 92 from leaking out by capillary action. That is, the lubricant 92 is present at least partially in between the base-side encircling member 112 and the sleeve 106. The first gas-liquid interface 116 of the lubricant 92 is in contact with both the inner circumferential surface 112a of the base-side encircling member 112 and the outer circumferential surface 106f of the lower part of the sleeve 106.

An annular sleeve recess 154 with the rotating axis R as the center is formed in the top face 106b of the sleeve 106. The sleeve recess 154 is dented downwardly. The ring portion 104 has a ring entry member 104b that enters the sleeve recess 154. As the ring entry member 104b enters the sleeve recess 154, a gap through which the ring entry member 104b and the sleeve recess 154 face each other is formed in the sleeve recess 154. In particular, this gap has a seventh gap 136 through which the ring entry member 104b and the sleeve recess 154 face each other in a radial direction of the ring portion 104 (in a direction intersecting perpendicularly with the rotating axis R), a ninth gap 140, and an eighth gap 138 through which the ring entry member 104b and the sleeve recess 154 face each other in a shaft direction (along the rotating axis R). The ninth gap 140 is located farther radially outward than the seventh gap 136.

The upper part 106d of the sleeve 106 circularly surrounds the ring entry member 104b. A second taper seal 118 is formed between the upper part 106d of the sleeve 106 and the ring entry member 104b. The second taper seal 118 is constituted by the ninth gap 140 provided between the upper part 106d and the ring entry member 104b, and the second taper seal 118 has a shape such that the size thereof gradually increases toward an upper side thereof. In particular, both an inner circumferential surface 106g of the upper part 106d and an outer circumferential surface 104c of the ring entry member 104b are formed such that the diameters thereof decrease toward the upper sides thereof. And the ratio of reduced diameter in the inner circumferential surface 106g is smaller than that in the outer circumferential surface 104c. As a result, a tapered shape of the second taper seal 118 is achieved. During a rotation of the rotating portion, a radially outward force caused by centrifugal force works on the lubricant 92 present within the second taper seal 118. The inner circumferential surface 106g of the upper part 106d is formed such that the diameter gets smaller toward the upper side thereof. Thus, said raidally outward force works in such a manner as to suck in the lubricant 92, namely, such that the lubricant 92 stays in the second taper seal 118.

In particular, the ring portion 104 is formed such that a maximum diameter D1 of the outer circumferential surface 104c of the ring entry member 104b is smaller than a minimum diameter D2 of the inner circumferential surface 106g of the upper part 106d. Thereby, at the time of manufacturing of the rotating apparatus 100, the ring portion 104 can be smoothly attached to the shaft 26 while the sleeve 106 is disposed relative to the shaft 26 in a loosely fitted state. The second taper seal 118 has a second gas-liquid interface 120 of the lubricant 92 and prevents the lubricant 92 from leaking out by capillary action. The second gas-liquid interface 120 of the lubricant 92 is in contact with both the inner circumferential surface 106g of the upper part 106d and the outer circumferential surface 104c of the ring entry member 104b.

If the eighth gap 138 is too wide, the volume of the lubricant 92 will rise unnecessarily and therefore the volume variation of the lubricant 92 caused by changes in temperature will be large. If, on the other hand, the eighth gap 138 is too narrow, the viscous resistance of the lubricant 92 in the eighth gap 138 will rise and therefore the electric power consumed by the rotating apparatus 100 may increase. In the light of these, the size (width) of the eighth gap 138 is so designed as to counter-balance these factors. For example, the width of the eighth gap 138 is preferably set to 0.03 to 0.50 if the viscosity of the lubricant 92 is 6 to 20 mm²/s at 40° C.

The first gap 126 has a first radial dynamic pressure generating part 156 and a second radial dynamic pressure generating part 158 each of which generates a radial dynamic pressure in the lubricant 92 when the sleeve 106 rotates relative to the shaft 26. The first radial dynamic pressure generating part 156 and the second radial dynamic pressure generating part 158 are spaced apart each other in a shaft direction of the rotating axis R. The first radial dynamic pressure generating part 156 is located above the second radial dynamic pressure generating part 158. A herringbone shaped or spiral shaped first radial dynamic pressure generating groove 50 is formed in a part of the inner circumferential surface 106a of the sleeve 106 corresponding to the first radial dynamic pressure generating part 156. A herringbone shaped or spiral shaped second radial dynamic pressure generating groove 52 is formed in a part of the inner circumferential surface 106a of the sleeve 106 corresponding to the second radial dynamic pressure generating part 158. At least one of the first radial dynamic pressure generating groove 50 and the second radial dynamic pressure generating groove 52 may be formed on the outer circumferential surface 26e of the connected portion in the shaft 26 instead of on the inner circumferential surface 106a of the sleeve 106.

The third gap 124 has a first thrust dynamic pressure generating part 160 that generates an axial dynamic pressure in the lubricant 92 when the sleeve 106 rotates relative to the shaft 26 and the housing 102. A herringbone shaped or spiral shaped first thrust dynamic pressure generating groove 54 is formed in a part of the underside 106c of the sleeve 106 corresponding to the first thrust dynamic pressure generating part 160. The first thrust dynamic pressure generating groove 54 may be formed on the top face 110b of the housing base 110 instead of on the underside 106c of the sleeve 106. The second gap 128 has a second thrust dynamic pressure generating part 162 that generates an axial dynamic pressure in the lubricant 92 when the sleeve 106 rotates relative to the shaft 26 and the ring portion 104. A herringbone shaped or spiral shaped second thrust dynamic pressure generating groove 56 is formed in a part of the top face 106b of the sleeve 106 corresponding to the second thrust dynamic pressure generating part 162. The second thrust dynamic pressure generating groove 56 may be formed on the underside 104a of the ring portion 104 instead of the top face 106b of the sleeve 106.

When the rotating portion rotates relative to the fixed portion, the first radial dynamic pressure generating groove 50, the second radial dynamic pressure generating groove 52, the first thrust dynamic pressure generating groove 54, and the second thrust dynamic pressure generating groove 56 each generates the dynamic pressure in the lubricant 92. The thus generated dynamic pressures support the rotating portion radially and axially while the rotating portion and fixed portion remain non-contact with each other. The positional relation between the sleeve recess 154 and the second thrust dynamic pressure generating part 162 is such that the second thrust dynamic pressure generating part 162 is located more radially inward than the sleeve recess 154. As for the positional relation between the first radial dynamic pressure generating part 156 and the second taper seal 118, the first radial dynamic pressure generating part 156 and the second taper seal 118 are partially overlapped with each other as viewed from a direction intersecting perpendicularly with the rotating axis R. In other words, if coordinate axes are defined in the shaft direction of the rotating axis R, the coordinate range of the second taper seal 118 and the coordinate range of the first radial dynamic pressure generating part 156 have some range in common with each other.

Thereby, the axial distance (bearing span) of the two radial dynamic pressure generating parts can be enlarged without being much restricted by the length of the taper seal, and the radial rigidity of the bearing can be enhanced. Conversely, a sufficient amount of lubricant 92 can be kept without much restricting the length of the taper seal by the bearing span, and the lubricant 92 can be restrained from being scattered. If the amount of lubricant 92 to be kept can be reduced, the ninth gap 140 and the fourth gap 132 can be made narrower correspondingly. As a result, for example, the leaking-out of the lubricant 92 in the case of being subjected to shock or impact can be reduced. The scattering of the lubricant 92 can be suppressed in the taper seal; even though the axial lengths of the two radial dynamic pressure generating parts are made larger and therefore the radial dynamic pressures are raised, the scattering of the lubricant 92 caused by an imbalance in the dynamic pressures generated then can be kept low. Thus, the radial dynamic pressure can be kept high and the rigidity can be enhanced while the scattering of the lubricant 92 is suppressed.

In particular, consider a situation where the thickness of a rotating apparatus is defined or predetermined by a standard or the like, or the thickness thereof cannot be increased in order to meet the thinning requirements. In such a case, by employing the rotating apparatus 100 according to the present embodiment, both the bearing span and the length of the taper seal can be set, almost independently of each other, to the lengths such that a prescribed thickness of the rotating apparatus 100 can be optimally used. In the present embodiment, the thickness of the rotating apparatus 100 with the top cover 2 attached thereon is 3 mm to 6 mm, particularly about 5 mm. Thus the present embodiment provides a thin rotating apparatus 100 that can keep a low error rate by increasing the rigidity of the bearing and that can also maintain a sufficient amount of lubricant 92, by providing the taper seal in a deeper position, even with use for a relatively long period of time.

The sleeve 106 is manufactured after brass or SUS430 has been subjected to a surface treatment. For example, a base material of SUS430 is cut into a desired shape and a thus cut-out metal first undergoes an electrolytic nickel plating so as to produce an underlying metal. Then an electroless nickel plating is performed; if brass is used, the electroless nickel plating only may suffice. Thereby, the surface hardness of the sleeve 106 increases and, in particular, the surface hardness of the sleeve 106 is higher than that of components in the fixed portion (i.e., the ring portion 104, the shaft 26, and the housing 102).

If the surface hardness of the components in the rotating portion is almost equal to the surface hardness of the components in the fixed portion, it is speculated, through the experiences by the inventors as the persons skilled in the art, that the burn-in is more likely to occur by the rotation of the rotating apparatus 100. In particular, the first thrust dynamic pressure generating part 160 and the second thrust dynamic pressure generating part 162 oftentimes rotate in contact state at the startup/stopping of the rotating apparatus 100 and therefore the burn-in is more likely to occur. In the present embodiment, the first thrust dynamic pressure generating groove 54 and the second thrust dynamic pressure generating groove 56 are formed in the sleeve 106 and then the nickel plating is performed thereon. As a result, a difference in surface hardness is made between the sleeve 106 and the components in the fixed portion. That is, the hardness of a part of the underside 106c of the sleeve 106 corresponding to the first thrust dynamic pressure generating part 160 differs from the hardness of a part of the top face 110b of the housing base 110 corresponding to the first thrust dynamic pressure generating part 160. Also, the hardness of a part of the top face 106b of the sleeve 106 corresponding to the second thrust dynamic pressure generating part 162 differs from the hardness of a part of the underside 104a of the ring portion 104 corresponding to the second thrust dynamic pressure generating part 162. As a result, the possibility that the burn-in will occur in the first thrust dynamic pressure generating part 160 and the second thrust dynamic pressure generating part 162 can be reduced. Note that the nickel plating may be performed on the components in the fixed portion.

The sleeve 106 has a bypass communicating hole 164 that bypasses the second thrust dynamic pressure generating part 162 and the first radial dynamic pressure generating part 156 and bypasses the second radial dynamic pressure generating part 158 and the first thrust dynamic pressure generating part 160. One end of the bypass communicating hole 164 is in the eighth gap 138, whereas the other end thereof is in between the first thrust dynamic pressure generating part 160 and the first taper seal 114. The bypass communicating hole 164 is a hole penetrating the sleeve 106 along the shaft direction of the rotating axis R.

The cover ring 12 is formed of SUS430, SUS303 or brass. The cover ring 12 is fixed to the hub 28 by bonding in such a manner as to cover the second gas-liquid interface 120 present in the ninth gap 140. The hub 28, the sleeve 106 and the cover ring 12 form a vapor catching space 170. The vapor catching space 170 communicates with the ninth gap 140. During a rotation of the sleeve 106, at least part of vapor of the lubricant 92 evaporated from the second gas-liquid interface 120 is captured in the vapor catching space 170 by centrifugal force. Thereby, the amount of vapor of the lubricant 92 discharged into the clean space 24 can be reduced.

A cover recess 172, which is dented downwardly, is formed in a top face 104d of the ring portion 104. The cover ring 12 has a ring protrusion 12a that enters the downwardly dented cover recess 172. A gap between the cover ring 12 and the ring portion 104 becomes minimum in a sixth gap 122 formed between the ring protrusion 12a and the cover recess 172. In this case, the exhaust resistance, which occurs when the vapor of the lubricant 92 evaporated from the second gas-liquid interface 120 is discharged into the clean space 24, can be increased and therefore the evaporation amount of the lubricant 92 can be reduced. Also, the exhaust resistance in the sixth gap 122 formed between the ring protrusion 12a and the cover recess 172 is dominant in the exhaust resistance occurring when the vapor of the lubricant 92 evaporated from the second gas-liquid interface 120 is discharged into the clean space 24. Thus, a change in the exhaust resistance is small even though the gaps other than the sixth gap 122 are widened. Hence, if the gaps other than the sixth gap 122 are designed to be wide, the processing and assembling of the rotating apparatus 100 become further facilitated and therefore the production efficiency can be improved.

A hub lower protrusion 28i, which is projected downwardly and circularly surrounds an upper end of the base protrusion 4e is formed in an underside 28b of the hub 28. Provision of the hub lower protrusion 28i can improve the rigidity of the hub 28. Also, a gap between the hub lower protrusion 28i and the base protrusion 4e can provide an additional labyrinth structure for the vapor of the lubricant 92 evaporated from the first gas-liquid interface 116.

An operation of the rotating apparatus 100 comprised of the above-described components is now described. A three-phase drive current is supplied to the coil 42 to rotate the magnetic recording disk 8. With the drive current flowing through the coil 42, a magnetic flux is produced along the nigh salient poles 40b. The magnetic flux gives a torque on the cylindrical magnet 32 and thereby the rotating portion and the magnetic recording disk 8 fitted to the rotating portion rotate. At the same time, the voice coil motor 16 has the swing arm 14 swing and thereby the read/write head moves back and forth on the magnetic recording disk 8 within a swingable range. The read/write head converts magnetic data recorded on the magnetic recording disk 8 into electric signals and then conveys the electric signals to a control board (not shown). And the electric signals sent from the control board are written onto the magnetic recording disk 8 as magnetic data.

Here, the bearing device installed in the rotating apparatus 100 according to the present embodiment has components for use in the bearing device where a lubricant layer is provided on the surface. In the configuration of the above-described rotating apparatus 100, the fluid dynamic pressure bearing unit, which includes the housing 102, the sleeve 106, the ring portion 104, the lubricant 92 and the shaft 26, corresponds to the rotating apparatus.

The bearing device includes a shaft body, a bearing body, having an inner circumferential surface circularly surrounding an outer circumferential surface of the shaft body via a gap, for housing the shaft body in a relatively rotatable manner, a lubricant present in a gap formed between the outer circumferential surface of the shaft body and the inner circumferential surface of the bearing body, and a radial dynamic pressure groove for generating a radial dynamic pressure in the lubricant, the radial dynamic pressure groove being provided on at least one of the outer circumferential surface and the inner circumferential surface. In the above-described rotating apparatus 100, the shaft 26 corresponds to the shaft body. Similarly, the outer circumferential surface 26e of the shaft 26 corresponds to the outer circumferential surface of the shaft body. The sleeve 106 corresponds to the bearing body. The inner circumferential surface 106a of the sleeve 106 corresponds to the inner circumferential surface of the bearing body. The first gap 126 corresponds to the gap formed between the outer circumferential surface and the inner circumferential surface. The lubricant 92 is the lubricant present in said gap. The first radial dynamic pressure generating groove 50 and the second radial dynamic pressure generating groove 52 correspond to the radial dynamic pressure groove. The above-described component(s) for use in the bearing device is at least one of the shaft body and the bearing body, namely, the shaft 26 and/or the sleeve 106. Where the component is the shaft body, namely, the shaft 26, the lubricant layer is provided on the outer circumferential surface, namely, the outer circumferential surface 26e of the shaft 26. Where the component is the bearing body, namely, the sleeve 106, the lubricant layer is the inner circumferential surface of the bearing body, namely, the inner circumferential surface 106a of the sleeve 106.

Or alternatively, the bearing device includes a rotating body, having a rotary body surface, which extends vertically to a rotating shaft, a static body having a stating body surface facing in axial opposition to the rotary body surface, namely, the static body surface overlapped with the rotary body surface as viewed from a direction along the rotating axis R, a lubricant present in a gap formed between the static body surface and the rotary body surface, and a thrust dynamic pressure groove for generating a thrust dynamic pressure in the lubricant, the thrust dynamic pressure groove being provided in at least one of the static body surface and the rotary body surface. In the above-described rotating apparatus 100, the sleeve 106 corresponds to the rotating body. Similarly, the top face 106b and the underside 106c of the sleeve 106 correspond to the rotary body surface. The housing 102 and the ring portion 104 correspond to the static body. The top face 110b of the housing 102 and the underside 104a of the ring portion 104 correspond to the static body surface. The second gap 128 and the third gap 124 correspond to the gap formed between the static body surface and the rotary body surface. The lubricant 92 is the lubricant present in said gap. The first thrust dynamic pressure generating groove 54 and the second thrust dynamic pressure generating groove 56 correspond to the thrust dynamic pressure groove. The above-described component(s) for use in the bearing device is at least one of the rotating body and the static body, namely, the sleeve 106 and/or the housing 102 and the ring portion 104. Where the component is the rotating body, namely, the sleeve 106, the lubricant layer is provided on the rotary body surface, namely, the top face 106b and the underside 106c of the sleeve 106. Where the component is the static body, namely, the housing 102 and the ring portion 104, the lubricant layer is provided on the static body surface, namely, the top face 110b of the housing 102 and the underside 104a of the ring portion 104.

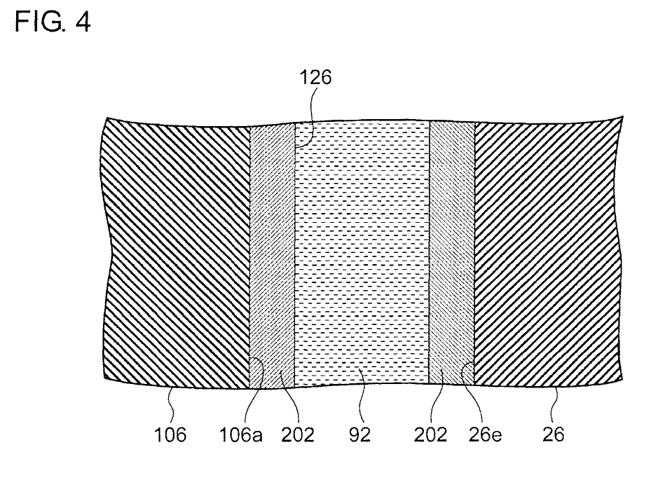

A description is now given of the lubricant layer in detail. FIG. 4 is a cross-sectional view showing a general structure of a component near the lubricant layer. FIG. 4 is an exemplary enlarged view of a neighborhood part of lubricant layers 202 provided in the outer circumferential surface 26e of the shaft 26 and the inner circumferential surface 106a of the sleeve 106. The lubricant layers 202 for other components are the same as those described herein and therefore the repeated explanation thereof will be omitted here. The lubricant layers 202 constitute the outermost layers of a component for use in the bearing device. In the bearing device according to the present embodiment, the lubricant layers 202 are provided on the outer circumferential surface 26e of the shaft 26, the inner circumferential surface 106a of the sleeve 106, the top face 106b and the underside 106c of the sleeve 106, the top face 110b of the housing 102, and the underside 104a of the ring portion 104, respectively. Provision of the lubricant layers 202 enable a pair of the outer circumferential surface 26e of the shaft 26 and the inner circumferential surface 106a of the sleeve 106, a pair of the top face 106b of the sleeve 106 and the underside 104a of the ring portion 104, and a pair of the underside 106c of the sleeve 106 and the top face 110b of the housing 102 to mutually slide in between each of the pairs while each pair is in contact with each other with the lubricant layer 202 applied therebetween. Thus the frictional wear of the surfaces of each component can be reduced and therefore the generation of abrasion powder can be prevented. Also, provision of the lubricant layers 202 can suppress the damage and deficiency resulting from the collision of two opposing components.

In the present embodiment, the lubricant layers 202 are provided on two mutually facing components. Accordingly, the generation of abrasion powder and foreign substances resulting from the deficiency or the like can be significantly suppressed as compared with the case where the lubricant layer 202 is provided on only one of the two mutually facing components. For the purpose of inhibiting the increase in the number of manufacturing processes and the increase in the manufacturing cost, the lubricant layer 202 may be provided on only one of each pair of two mutually facing components. Also, the lubricant layer 202 may be formed on the entire surface of each component or may be formed on a partial part of the surface of each component. If the lubricant layer 202 is formed partially on the surface thereof, the lubricant layers 202 may be formed on the regions of the first radial dynamic pressure generating part 156, the second radial dynamic pressure generating part 158, the first thrust dynamic pressure generating part 160 and the second thrust dynamic pressure generating part 162 only, for instance. If the lubricant layer 202 is formed on the entire surface thereof, the process for forming the lubricant layers 202 can be simplified; if the lubricant layer 202 is formed partially on the surface thereof, the consumption of lubricant-layer-forming compositions can be reduced. Also, if the lubricant layer 202 is provided on at least one of the outer circumferential surface 26e of the shaft 26, the inner circumferential surface 106a of the sleeve 106, the top face 106b of the sleeve 106, the underside 106c of the sleeve 106, the top face 110b of the housing 102, and the underside 104a of the ring portion 104, the occurrence of foreign substances can be suppressed in the bearing device as a whole.

A description is given herein using the shaft 26 and the sleeve 106 as examples. The lubricant layers 202 are provided beforehand on the shaft 26 and the sleeve 106 before assembly, namely, each formed beforehand on the shaft 26 and the sleeve 106 individually and independently. As the shaft 26 having the lubricant layer 202 formed thereon and the sleeve 106 having the lubricant layer 202 formed thereon are assembled together and then the lubricant 92 is filled into the first gap 126, the lubricant layers 202 on the outer circumferential surface 26e, the lubricant 92 and the lubricant layer 202 on the inner circumferential surface 106a are structured as a three-layer structure in a region between the outer circumferential surface 26e of the shaft 26 and the inner circumferential surface 106a of the sleeve 106. The lubricant layers 202 are provided before the shaft 26 are the sleeve 106 are assembled. Thus the lubricant layer 202 can be evenly formed on the surface of each component. As a result, strongly constructed lubricant layers 202 can be formed. Also, the lubricant layer 202 provided on the surface of each component can be simply and accurately inspected. Since, in the present embodiment, the lubricant layers 202 are formed on the entire surfaces of the shaft 26 and the sleeve 106, the lubricant layers 202 are also provided on regions of their surfaces other than those regions in the surfaces coming into contact with the lubricant 92.

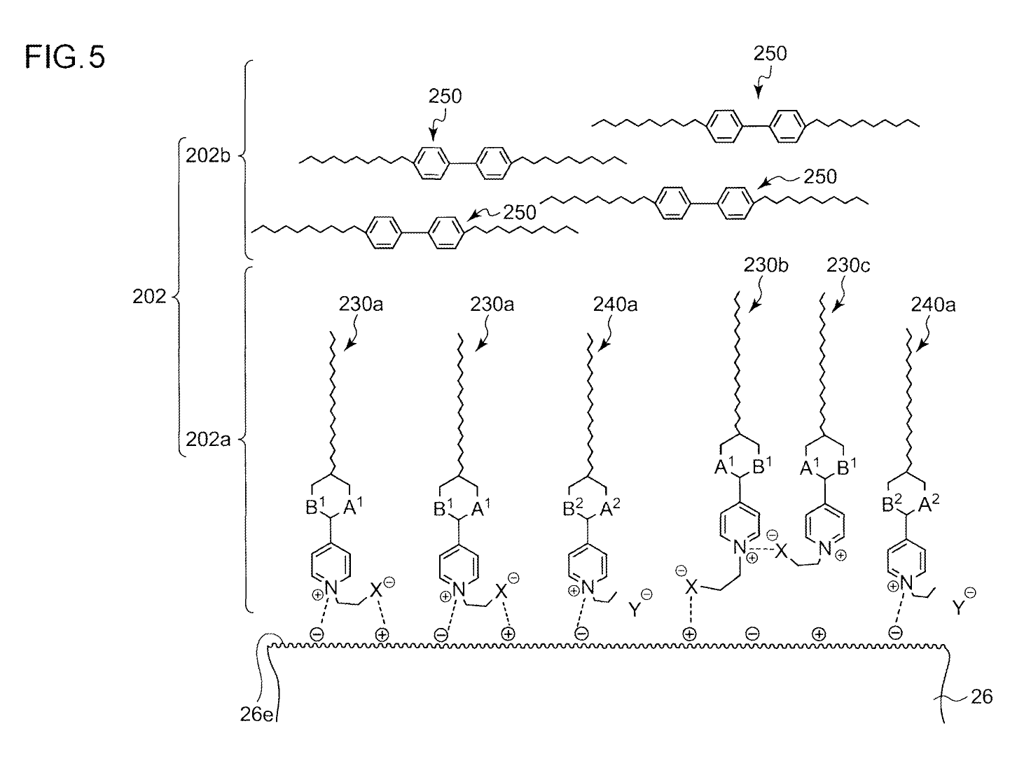

FIG. 5 is an enlarged schematic illustration of a part of a lubricant layer. Note that FIG. 5 shows an exemplary state where a first pyridinium salt type liquid crystal compound and a second pyridinium salt type liquid crystal compound described later are mixed. Also, FIG. 5 shows, as an example, the lubricant layer 202 provided in the outer circumferential surface 26e of the shaft 26. Since the lubricant layers 202 for other components will have the same structure as this, the repeated explanation of other components will be omitted. The lubricant layer 202 contains a rod-like ionic liquid crystal compound having a cation group and an anion group. The cation group in the rod-like ionic liquid crystal compound is preferably a pyridinium group. That is, the rod-like ionic liquid crystal compound is preferably a pyridinium salt type liquid crystal compound. Such a pyridinium salt type liquid crystal compound may be the first pyridinium salt type liquid crystal compound represented by the following formula (1) and the second pyridinium salt type liquid crystal compound represented by the following formula (2), for instance.

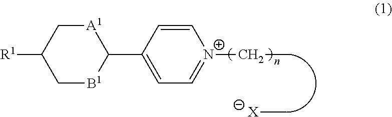

[In the formulas (1), R¹ is an alkyl group, an alkoxy group, or a group having an unsaturated bond represented by the following formula (3). A¹ and B¹ are each independently O, S, NH or CH₂. X⁻ is SO₃⁻, COO⁻, PO₃⁻, or PO₃²⁻. “n” is an integer greater than or equal to “0”.]

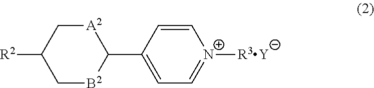

[In the formulas (2), R² and R³ are each independently an alkyl group, an alkoxy group, or a group having an unsaturated bond represented by the following formula (3). A² and B² are each independently O, S, NH or CH₂. Y⁻ is a halogen atom.]

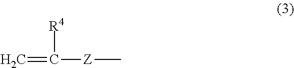

[In the formulas (3), R⁴ is H or CH₃, and Z is (CH₂)ₘ, (CH₂)ₘ—O, CO—O—(CH₂)ₘ, CO—O—(CH₂)ₘ—O, C₆H₄—CH₂—O, or CO. “m” is any one of integers 1 to 30.]

In the formula (1), the alkyl group of R¹ is a straight-chain or branched-chain alkyl group. A carbon number of alkyl group may preferably be 3 to 24, more preferably 5 to 22, and most preferably 8 to 18. Setting the carbon number of alkyl to 3 or greater can achieve the lubrication effect of the lubricant layer 202 more reliably. Also, setting the carbon number of alkyl to less than or equal to 24 enables the rod-like ionic liquid crystal compound contained in the lubricant layer 202 to be less likely to be crystallized. An example of the alkyl group of R¹ may be a methyl group, ethyl group, butyl group, pentyl group, hexyl group, octyl group, dodecyl group, pentadecyl group, octadecyl group, or the like.

The alkoxy group R¹ is a straight-chain or branched-chain alkoxy group. This alkoxy group may preferably be an alkoxy group represented by C_{q}H(2_{q}+1)O— where q is preferably 1 to 30 and more preferably 7 to 22.

In the above formula (1), n may preferably be any one of 1 to 20, more preferably any one of 1 to 5, and most preferably 3 or 4. Setting n to be 1 or greater enables the cation group (X⁻) of the first pyridinium salt type liquid crystal compound to be more likely to be bonded to a positive ion portion on the surface of an underlying layer (the outer circumferential surface 26e of the shaft 26) of the lubricant layer 202. Also, setting n to be less than or equal to 20 suppresses a steric hindrance caused by an alkyl chain and enables a positive ion portion (N⁺) of the first pyridinium salt type liquid crystal compound to be more likely to form an ionic bond with a negative ion portion in the surface of the underlying layer of the lubricant layer 202.

In the second pyridinium salt type liquid crystal compound expressed by the above formula (2), the alkyl group R² is a straight-chain or branched-chain alkyl group and the carbon number may preferably be 3 to 24, more preferably 5 to 22, and most preferably 8 to 18, similarly to R¹ of the formula (1). The preferably range of the carbon numbers may be determined in view of achieving the lubrication effect of the lubricant layer 202 and in view of suppressing the crystallization of the rod-like ionic liquid crystal compound. An example of the alkyl group of R² may be similar to that of R².

The alkyl group R³ is a straight-chain or branched-chain alkyl group, and the carbon number may preferably be 0 to 20 and more preferably 0 to 3. Setting the carbon number to be less than or equal to 20 suppresses the steric hindrance caused by an alkyl chain and enables a positive ion portion (N⁺) of the second pyridinium salt type liquid crystal compound to be more likely to form an ionic bond with the negative ion portion in the surface of the underlying layer of the lubricant layer 202.

The alkoxy groups R² and R³ are each a straight-chain or branched-chain alkoxy group, similarly to R¹ of the formula (1) and may preferably be an alkoxy group represented by C_{q}H(2_{q}+1)O—. The q in the alkoxy group R² is preferably 1 to 30 and more preferably 7 to 22. The q in the alkoxy group R³ is preferably 0 to 20 and more preferably 0 to 3.

The entire lengths of the first pyridinium salt type liquid crystal compound and the second pyridinium salt type liquid crystal compound may be adjusted by adjusting the lengths of R¹ and R², respectively. For example, the sizes of these pyridinium salt type liquid crystal compounds may be such that the length of their liquid crystal portions, namely those including two ring structures, is about 1 nm and the lengths of R¹ and R² are about 1 to 2 nm. Thus the total length will be about 2 to 3 nm, for instance.

The rod-like ionic liquid crystal compound constituting the lubricant layer 202 has a cation group and an anion group at the terminals as described above. On the other hand, as shown in FIG. 5, the outer circumferential surface 26e of the shaft 26 has a positive ion portion and a negative ion portion due to the bias of charge. As a result, the cation group of the rod-like ionic liquid crystal compound forms an ionic bond with the negative ion portion of the outer circumferential surface 26e, or the anion group of the rod-like ionic liquid crystal compound forms an ionic bond with the positive ion portion of the outer circumferential surface 26e. For example, with a first pyridinium salt type liquid crystal compound 230a, the cation group thereof forms an ionic bond with the negative ion portion of the outer circumferential surface 26e, and the anion group thereof forms an ionic bond with the positive ion portion of the outer circumferential surface 26e. Also, with the second pyridinium salt type liquid crystal compound 240a, the cation group thereof forms an ionic bond with the negative ion portion of the outer circumferential surface 26e.

The first pyridinium salt type liquid crystal compound and the second pyridinium salt type liquid crystal compound can exist not only in a bond with the outer circumferential surface 26e, but also in an ionic bond with the cation group or the anion group of the rod-like ionic liquid crystal compound bound to the outer circumferential surface 26e. For example, with a first pyridinium salt type liquid crystal compound 230b, the anion group thereof forms an ionic bond with the positive ion portion of the outer circumferential surface 26e, and the cation group thereof forms an ionic bond with the anion group of a first pyridinium salt type liquid crystal compound 230c. The first pyridinium salt type liquid crystal compound 230c is bonded to the outer circumferential surface 26e via the first pyridinium salt type liquid crystal compound 230b. It is to be noted that the lubricant layer 202 is not limited to a mixture of the first pyridinium salt type liquid crystal compound and the second pyridinium salt type liquid crystal compound. The lubricant layer 202 may serve the objective of the present invention if it contains at least one of the first pyridinium salt type liquid crystal compound and the second pyridinium salt type liquid crystal compound.

Thus, the rod-like ionic liquid crystal compound is firmly bound in an ionic bond with the surface of the outer circumferential surface 26e of the shaft 26 directly or through another rod-like ionic liquid crystal compound, thereby forming a regularly vertical sequence in relation to the surface of the outer circumferential surface 26e. That is, the lubricant layer 202 has a film of a smectic liquid crystal phase of the rod-like ionic liquid crystal compound in a uniformly vertical sequence. With the lubricant layer 202 having this film, the shaft 26 can be reliably protected against the contact or collision of the sleeve 106. Also, this film works to reduce the friction coefficient of the lubricant layer 202, thereby lessening the risk of damage to the shaft 26.

In the lubricant layer 202, the terminal portions of the rod-like ionic liquid crystal compound are in an ionic bond with the outer circumferential surface 26e. Hence, the rod-like ionic liquid crystal compound seldom separates from the outer circumferential surface 26e and is least likely to disappear through evaporation. Accordingly, the lubricant layer 202 does not easily get peeled or sustain damage even when the sleeve 106 comes in contact with or collides with the shaft 26. As a result, the possibility that foreign substance may be produced resulting from the friction and collision between the shaft 26 and the sleeve 106 can be reduced over a long period of time. Thus, the life of the bearing device can be extended.

Preferably, the lubricant layer 202 has a monomolecular layer 202a of the rod-like ionic liquid crystal compound in at least a part of the region where it is in contact with the surface of a component (the outer circumferential surface 26e). More preferably, the lubricant layer 202 is the monomolecular layer 202a in its entirety. The lubricant layer 202, if it is comprised of a monomolecular layer 202a of the rod-like ionic liquid crystal compound, can be made thinner in its layer thickness. When the lubricant layer 202 is comprised of a monomolecular layer 202a, the layer thickness of the lubricant layer 202 can be approximately equal to the length of the rod-like ionic liquid crystal compound, namely, about 2 to 3 nm, for example. Note that the layer thickness of the lubricant layer 202 can be measured with an ellipsometer. The monomolecular layer 202a can be formed by adjusting the content of the rod-like ionic liquid crystal compound in the lubricant-layer-forming composition for forming the lubricant layer 202.

Also, preferably, the lubricant layer 202 contains at least one of a non-ionic liquid crystal compound and a non-ionic lubricant. As the non-ionic liquid crystal compound, a non-ionic liquid crystal compound generally known in the art, such as those represented by the following formulas (4) to (13), may be used.

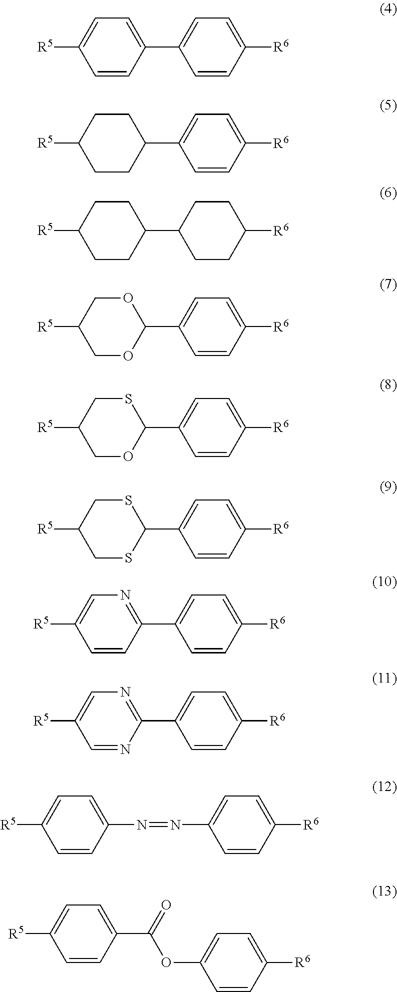

[In the formulas (4) to (13), R⁵ and R⁶ are each independently a straight-chain or branched-chain alkyl group.]

Also, as the non-ionic lubricant, a generally known lubricant, such as an ether-, ester-, or olefin-based lubricant, may be used.

The rod-like ionic liquid crystal compound has a higher affinity for the outer circumferential surface 26e with a bias of charge than the non-ionic liquid crystal compound or lubricant. Accordingly, when the lubricant layer 202 contains a non-ionic liquid crystal compound or lubricant in addition to the rod-like ionic liquid crystal compound, the rod-like ionic liquid crystal compound, as shown in FIG. 5, will move toward the outer circumferential surface 26e, thus forming a monomolecular layer 202a in the interfacial region facing the outer circumferential surface 26e. And the non-ionic liquid crystal compound or lubricant will form a non-ionic compound layer 202b above the monomolecular layer 202a. The non-ionic compound layer 202b is effective in preventing moisture from entering the bearing device from the surface of the lubricant layer 202. This allows the rod-like ionic liquid crystal compound to be bound more firmly to the outer circumferential surface 26e. The lubricant layer 202 according to the present embodiment is such that it contains a non-ionic liquid crystal compound 250 of a biphenyl structure (R⁵ and R⁶ being an alkyl group of carbon number 10) as represented by the above formula (4) as the non-ionic liquid crystal compound, and the non-ionic compound layer 202b is formed by the non-ionic liquid crystal compound 250. It should be noted here that one or both of the non-ionic liquid crystal compound and the non-ionic lubricant may be used. Also, one type only for each of them may be used, or a combination of two types or more for each of them may be used.

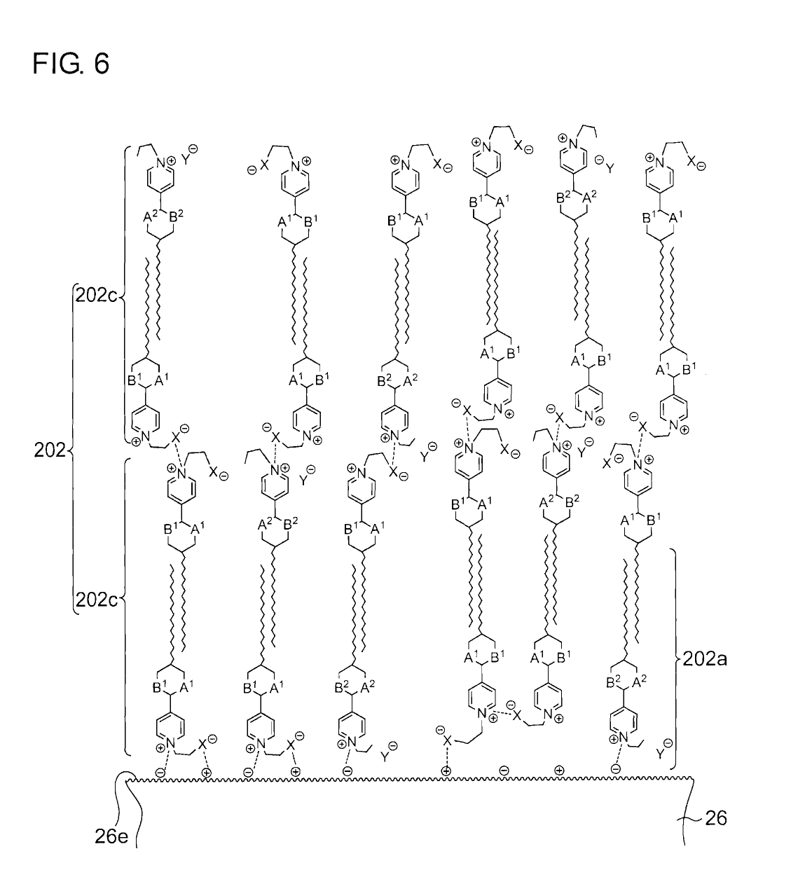

When the content of the rod-like ionic liquid crystal compound in the lubricant-layer-forming composition exceeds the content needed to form the monomolecular layer 202a, the lubricant layer 202 will assume a structure in which the rod-like ionic liquid crystal compounds are stacked as shown in FIG. 6. FIG. 6 is an enlarged schematic illustration of a part of a lubricant layer having a structure of stacked rod-like ionic liquid crystal compounds. That is, a part of the rod-like ionic liquid crystal compound contained in the lubricant layer 202 is adsorbed to the rod-like ionic liquid crystal compound forming the monomolecular layer 202a as the R¹ portion in the above formula (1) or the R² portion in the above formula (2) having a hydrocarbon chain gets close to the R¹ portion or the R² portion of the rod-like ionic liquid crystal compound forming the monomolecular layer 202a through a hydrophobic interaction or the like.

As a result, a double layer 202c of rod-like ionic liquid crystal compounds is formed. In the double layer 202c, the rod-like ionic liquid crystal compound of a first layer and the rod-like ionic liquid crystal compound of a second layer are sequenced in such a manner that the end portions having a cation group or an anion group face outward, respectively. Therefore, another double layer 202c can be stacked on the surface of the double layer 202c bound to the outer circumferential surface 26e if an ionic bond of the cation group and/or the anion group of the other double layer 202c is established. In other words, a plurality of double layers 202c are repetitively stacked on top of each other, depending on the contained amount of the rod-like ionic liquid crystal compound in the lubricant-layer-forming composition. The layer thickness of the lubricant layer 202 can be adjusted by selecting the number of double layers 202c stacked. FIG. 6 shows a lubricant layer 202 having a structure of two stacked double layers 202c as an example. It is to be noted that if the lubricant layer 202 contains a non-ionic liquid crystal compound or a non-ionic lubricant, a non-ionic compound layer 202b (see FIG. 5) will be formed on top of the stacked structure of the double layers 202c.

The rod-like ionic liquid crystal compound constituting the lubricant layer 202 takes a crystal (solid) state or a smectic liquid crystal state at normal temperature. It should be noted that the rod-like ionic liquid crystal compound, when it takes a smectic liquid crystal state at normal temperature, exists in a glassy state in the lubricant layer 202. And when the rotating apparatus 100 is driven and then the sleeve 106 starts to rotate relative to the shaft 26, the rod-like ionic liquid crystal compound undergoes a phase transition from the crystal state to the smectic liquid crystal state due to the friction heat, or makes a transition from a glassy state to the smectic liquid crystal state. Also, it is to be noted that the rod-like ionic liquid crystal compound can make a phase transition from a smectic liquid crystal state to a liquid state due to the frictional heat. It is considered that rod-like ionic liquid crystal compound in a liquid state exerts high meniscus force, thereby improving the rotating stability of the sleeve 106.

The phase transition temperature of the rod-like ionic liquid crystal compound constituting the lubricant layer 202 varies with the structure thereof. For example, for the second pyridinium salt type liquid crystal compound of which A² and B² are O, R³ is C₂H₅, and Y is Br in the above formula (2), the phase transition temperature from the crystal phase to the smectic A liquid crystal phase is 35° C., and the phase transition temperature in the reverse direction −25° C., when R² is C₇H₁₅. Also, when R² is C₁₀H₂₁, the phase transition temperature from the crystal phase to the smectic A liquid crystal phase is 60° C., the phase transition temperature in the reverse direction is −25° C., and the phase transition temperature from the smectic A liquid crystal phase to the isotropic liquid phase and that in the reverse direction are both 139° C. Also, when R² is C₉H₁₉, the phase transition temperature from the crystal phase to the smectic A liquid crystal phase is 77° C., the phase transition temperature in the reverse direction is −1° C., and the phase transition temperature from the smectic A liquid crystal phase to the isotropic liquid phase and that in the reverse direction are both 100° C. Also, when R² is C₁₁H₂₃, the phase transition temperature from the crystal phase to the smectic A liquid crystal phase is 88° C., the phase transition temperature in the reverse direction is −18° C., and the phase transition temperature from the smectic A liquid crystal phase to the isotropic liquid phase and that in the reverse direction are both 180° C.

The lubricant layer 202 may contain only one type of rod-like ionic liquid crystal compound. However, from the viewpoint of easier adjustment of the phase transition temperature of the lubricant layer 202, it is preferable that the lubricant layer 202 contains plural types of rod-like ionic liquid crystal compounds. The lubricant layer 202 containing plural types of rod-like ionic liquid crystal compounds can have a greater degree of freedom in adjusting the phase transition temperature thereof than the lubricant layer 202 containing only one type of rod-like ionic liquid crystal compound. It is to be noted here that the aforementioned case of the lubricant layer 202 containing plural types of rod-like ionic liquid crystal compounds includes the following cases. That is, the aforementioned case includes a case where one type each of the first pyridinium salt type liquid crystal compound and the second pyridinium salt type liquid crystal compound are contained, a case where plural types of one of them only are contained, a case where plural types of one of them and one type of the other are contained, and a case where plural types of both of them are contained. The temperature range in which the lubricant layer 202 takes a liquid state can be widened by mixing plural types of rod-like ionic liquid crystal compounds into the lubricant-layer-forming composition and adjusting the compounding ratio as appropriate. As a result, the temperature range in which the bearing device can be used in optimal conditions can be widened. For example, the lubricant layer 202 is designed such that the phase transition temperature from the smectic liquid crystal state to the liquid state is in the neighborhood of 100° C.

<Method for Preparation of Lubricant-Layer-Forming Composition>

(Synthesis of First Pyridinium Salt Type Liquid Crystal Compound)

The first pyridinium salt type liquid crystal compound as represented by the above formula (1) can be synthesized, for example, by causing a reaction between the compound represented by the formula (15) below and the compound represented by the formula (16) below in a solvent according to the reaction formula (14) below.

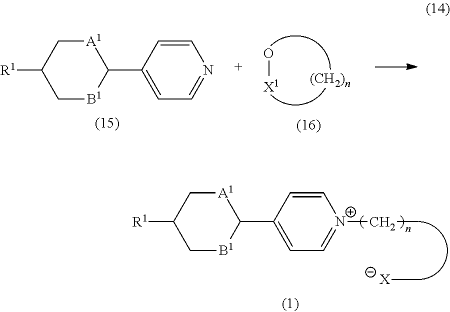

[R¹, A¹, B¹, X, and n in the reaction formula (14) are synonymous with those in the above formula (1). X¹ represents SO₂, CO, or P(O)(OH).]

In the reaction of the reaction formula (14), the compound represented by the formula (15) and the compound represented by the formula (16) are introduced into a solvent, such as acetonitrile, at a molar ratio of the latter to the former of 0.90 to 1.10, or more preferably 0.95 to 1.05. And the first pyridinium salt type liquid crystal compound can be synthesized through a reaction in an inert atmosphere, such as nitrogen, at 10 to 100° C., or more preferably at 50 to 90° C., for 1 to 60 hours, or more preferably for 10 to 50 hours.

The compound represented by the above formula (15), which is one of the starting materials, is a known compound. For example, a compound for which A¹ and B¹ in the formula (15) are an oxygen atom or a sulfur atom can be manufactured according to a reaction scheme (1) below. That is, a malonic acid ester (17) and a halide (R¹X′) are first reacted with each other to obtain an R¹-introduced malonate (18). Then the R¹-introduced malonate (18) is resolved with LiAlH₄ into a compound (19a) (R¹-introduced 1,3-pronanediol). Also, if necessary, the reactions are continued to synthesize a compound (19b) through a compound (20) from the compound (19a). Or alternatively a compound (19c) is synthesized through a compound (21) from the compound (19a). Following this, the thus obtained compound (19a), compound (19b), or compound (19c) is reacted with pyridine-4-aldehide (22) to obtain a compound (15) (see Japanese Unexamined Patent Application Publication No. Hei10-53585, Japanese Unexamined Patent Application Publication No. Hei10-338691, Japanese Unexamined Patent Application Publication No. 2000-86656), and “Liquid crystals”, 1999, Vol. 26, No. 10, 1425-1428).

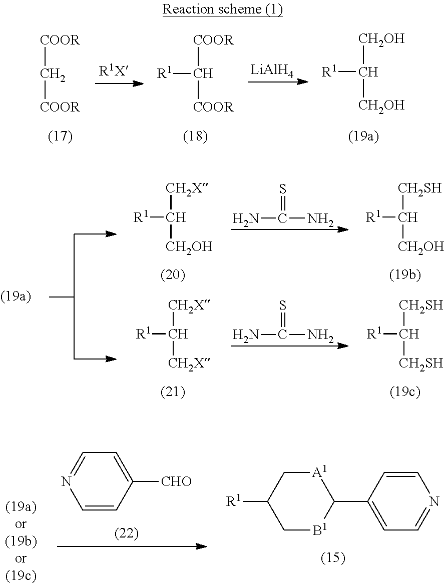

[In the reaction scheme (1), R¹ is synonymous with that in the above formula (1). A¹ and B¹ represent O or S independently. R represents an alkyl group. X′ and X″ each represent a halogen atom.]

A compound for which A¹ and B¹ in the above formula (15) are CH₂ can be manufactured according to the reaction scheme (2) below. That is, a 4-substituted phenol (23) is first reacted with hydrogen in the presence of a catalytic reduction catalyst, such as Raney nickel or Raney cobalt to synthesize a 4-substituted cyclohexanol (24) (see Japanese Unexamined Patent Application Publication No. Sho58-164676, Japanese Unexamined Patent Application

Publication No. Hei2-131405), and U.S. Pat. No. 3,322,619, for instance). Then the thus obtained 4-substituted cyclohexanol (24) is reacted with pyridine-4-aldehide (22) to obtain the compound (15).

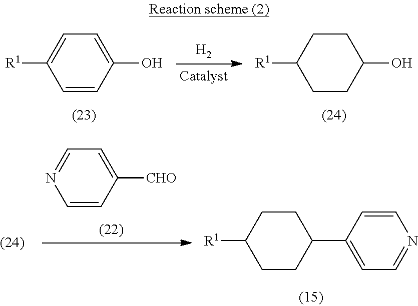

[In the reaction scheme (2), R¹ is synonymous with that in the above formula (1).]

Also, a compound for which X′ in the above formula (16) is SO₂ or CO, which is the other of the starting materials in the above formula (16), may be selected from commercially available products. Also, a compound for which X¹ in the above formula (16) is P(O)(OH) can be obtained through the compound (26) represented by the formula (26) below and the compound represented by the formula (27) below from the compound represented by the formula (25) below according a reaction scheme (3) below (see “Journal of the American Chemical Society”, Vol. 87, No. 2, pp. 253-260, 1965, for instance).

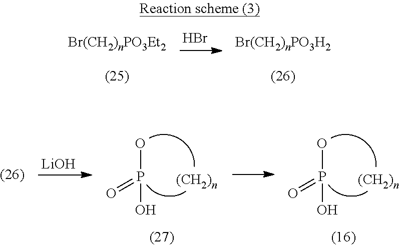

[In the reaction scheme (3), n is synonymous with that in the above formula (1).]

(Synthesis of Second Pyridinium Salt Type Liquid Crystal Compound)

The second pyridinium salt type liquid crystal compound represented by the above formula (2) may be synthesized according to the reaction formula (28) below, for example. That is, a compound (29) is first obtained by following a similar procedure to the above reaction scheme (1). Then the thus obtained compound (29) and a halide (30) are reacted with each other to obtain the second pyridinium salt type liquid crystal compound (see Japanese Unexamined Patent Application Publication No. Hei10-53585, Japanese Unexamined Patent Application Publication No. 2000-86723, Japanese Unexamined Patent Application Publication No. 2000-86656, and “Liquid Crystals”, 1999, Vol. 26, No. 10, pp. 1425-1428, for instance).

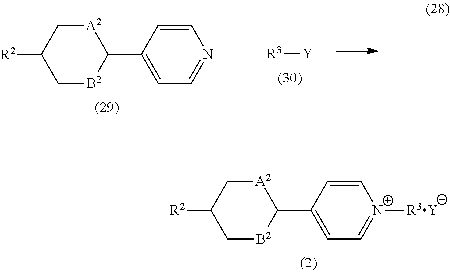

[R², R³, A², B², and Y in the reaction formula (28) are synonymous with those in the above formula (2).]

The lubricant-layer-forming composition may be prepared as follows. That is, the first pyridinium salt type liquid crystal compound and/or the second pyridinium salt type liquid crystal compound as obtained above and, if necessary, non-ionic liquid crystal compound and a non-ionic lubricant are/is added to a solvent such as alcohol and mixed together so as to prepare the lubricant-layer-forming composition. The solvent is not limited to any particular one as long as the rod-like ionic liquid crystal compound and the like can be dissolved with it. The content of the rod-like ionic liquid crystal compound in the lubricant-layer-forming composition may be 0.001 wt % to 10 wt % of the total amount of the lubricant-layer-forming composition, for instance.

<Method for Forming Lubricant Layers>

The lubricant layers 202 may be provided on the surface of a component for use in a bearing device, as follows. A description is given here of a case where the lubricant layer 202 is provided on the outer circumferential surface 26e of the shaft 26. That is, a lubricant-layer-forming composition that contains a rod-like ionic liquid crystal compound having a cation group and an anion group is first adhered to the outer circumferential surface 26e of the shaft 26. A method employed for depositing or applying the lubricant-layer-forming composition to a base material may be a dip method, a spraying method, a spin coating method, a cast method, a vacuum evaporation method, or the like, for instance. In the present embodiment, the lubricant-layer-forming composition is adhered to the entire surface of the shaft 26. In this case, a process of masking a region where the lubricant-layer-forming composition is not adhered is no longer required, so that the process of forming the lubricant layer 202 can be simplified. Then the lubricant-layer-forming composition adhered to the outer circumferential surface 26e is heated. Though this heating process, the solvent in the lubricant-layer-forming composition is vaporized and the rod-like ionic liquid crystal compound is formed into a regularly vertical sequence. The heating temperature may be 50 to 150° C., for instance, and the heating time may be 1 to 60 minutes, for instance. As an example, the lubricant-layer-forming composition applied thereto is heated at 80° C. for 10 minutes.

After the lubricant-layer-forming composition has been applied onto the outer circumferential surface 26e, a process in which the surface of coated film of the lubricant-layer-forming composition is leveled off to achieve a uniform thickness of the coated surface thereof may be carried out before the heating process. This allows the layer thickness of the lubricant layer 202 to be uniform. As a result, the distance between the lubricant layer 202 formed on the outer circumferential surface 26e and the lubricant layer 202 formed on the inner circumferential surface 106a of the sleeve 106 can be made uniform. Thus, the relative rotation of the shaft 26 and sleeve 106 can be stabilized. The lubricant layer 202 is preferably formed of a substance whose surface energy is low. This can suppress the other materials from being adsorbed onto the outer circumferential surface 26e.

In the present embodiment, a lubricant that does not contain the rod-like ionic liquid crystal compound is used as the lubricant 92. However, this should not be considered as limiting, and the lubricant 92 may contain the rod-like ionic liquid crystal compound. Consider here a case where no lubricant layers 202 is provided on the outer circumferential surface 26e of the shaft 26 and the inner circumferential surface 106e of the sleeve 106 and where the lubricant 92 containing the rod-like ionic liquid crystal compound is filled into the first gap 126. In this case, the rod-like ionic crystal liquid compound in the lubricant 92 is bonded to the circumferential surface 26e and the inner circumferential surface 106a and therefore a layer of the rod-like ionic liquid crystal compound (hereinafter referred to as “quasi lubricant layer” as appropriate) will possibly be formed on the outer circumferential surface 26e and the inner circumferential surface 106a. However, the quasi lubricant layer completely differs in structure from the above-described lubricant layer 202 obtained after a heating process. That is, in the lubricant layer 202, the regularity of the rod-like ionic liquid crystal compound is higher than that in the quasi lubricant layer and therefore the lubricant layer 202 has a more uniformly bonded structure in the surface of each component. A person skilled in the art can distinguish between the quasi lubricant layer and the lubricant layer 202, based on the high regularity of the rod-like ionic liquid crystal component bonded onto the outer circumferential surface 26e and the inner circumferential surface 106a, the uniformity in the bonding onto them, the density thereof and the like.

As described above, each component for use in the bearing device according to the embodiments of the present invention has the lubricant layer 202, which contains the rod-like ionic liquid crystal compound having a cation group and an anion group, on the surface. Provision of the lubricant layers 202 can reduce the generation of abrasion powders (foreign substances) as a result of a component, for use in the bearing device, coming into contact with other components and the generation of fragments as a result of damage caused by the collision of the component with other components. In particular, if the component is the shaft body and/or the bearing body (or the rotating body and/or static body), the shaft body and the bearing body (or the rotating body and the static body) may come into contact with each other during a low-speed rotation such as at the start of rotation or at deceleration and therefore the abrasion powder may possibly generated. An equipment where the rotating apparatus is installed is possibly dropped or so forth, so that the apparatus may be damaged due to a collision of the component with other components and there may be broken pieces. Thus, providing the lubricant layers 202 in these components can suppress the occurrence of foreign substances and can extend the life of the bearing device. Also, the rod-like ionic liquid crystal compound is uniformly formed in a vertical sequence in the lubricant layer 202. And formed is a film of the rod-like ionic liquid crystal compound in a strong ionic bond with the underlying surface. Thereby, the lubricant layer 202 seldom separates from the surface of the components and the generation of foreign substances can be suppressed over a long period of time. Hence, the life of the bearing device can be further extended.

The present invention is not limited to the above-described embodiments only, and it is understood by those skilled in the art that changes in design may be added to the embodiments based on their knowledge and the embodiments added with such modifications are also within the scope of the present invention. New embodiments arising from the added modifications and a combination thereamong also enjoy the advantageous effects of their respective embodiments combined.

In the above-described embodiments, a description has been given of a rotating apparatus of a so-called outer rotor type where the cylindrical magnet 32 is disposed outside the laminated core 40, but the present embodiments are not limited thereto. For example, the rotating apparatus may be of a so-called inner rotor type where the cylindrical magnet 32 is disposed inside the laminated core 40. Also, in the above-described embodiments, a description has been given of a case where the housing 102 is directly attached to the base 4, but the present embodiments are not limited thereto. For example, a configuration may be such that a brushless motor comprised of a rotating portion and a fixed portion is first formed separately and then this brushless motor is attached to a chassis. In the above-described embodiments, a description has been given of a case where the laminated core 40 is used, but this should not be considered as limiting and the core may not be the limited core.

Still another embodiments of the present invention relates also to a bearing device comprised of the components, for use in the bearing device, according to the above-described embodiments, and the rotating apparatus 100 or a desk drive device, where said bearing device is installed. Also, still another embodiments of the present invention relates to a method for manufacturing a bearing device. This method includes a process for applying a lubricant-layer-forming composition containing the rod-like ionic liquid crystal compound having the cation group and the anion group, to at least one surface of the shaft body and the bearing body, a process for heating the lubricant-layer-forming composition applied to the surface thereof so as to form a lubricant layer, a process for receiving and holding the shaft body in the bearing body, and a process for filling the gaps between the outer circumferential surface of the shaft body and the inner circumferential surface of the bearing body with lubricants. Also, still another embodiments of the present invention relates to a method for manufacturing a bearing device. This method includes a process for applying a lubricant-layer-forming composition containing the rod-like ionic liquid crystal compound having the cation group and the anion group, to at least one surface of the rotating body and the static body, a process for heating the lubricant-layer-forming composition applied to the surface thereof so as to form a lubricant layer, a process for assembling the rotating body and the static body, and a process for filling the gaps between a surface of the rotating body and a surface of the static body with lubricants. Also, still another embodiments of the present invention provides a method for installing the bearing device that has been manufactured using each of these methods for manufacturing the bearing device.

A description is now given of an exemplary embodiment, which is a mere example to explain the present invention and does not limit the present invention in any way.

### Exemplary Embodiment

As the rod-like ionic liquid crystal compound, a 5 mg of the second pyridinium salt type liquid crystal compound, of which A² and B² are O, R³ is C₂H₅, R² is O₁₀H₂₁, and Y is Br in the above formula (2), was added to a 1 ml of ethanol and then dissolved so as to prepare a lubricant-layer-forming composition according to an exemplary embodiment. The thus obtained lubricant-layer-forming composition was spin-coated on a stainless plate (SUS 304 plate), which serves as a test specimen, by use of a spin coater. Then the test specimen is placed and held on a hot plate and is heated at 80° C. for 30 minutes.

The test specimen coated with the lubricant-layer-forming composition according to the exemplary embodiment was placed and held on a surface nature measuring instrument (TYPE 14FW, manufactured by SHINTO scientific Co., Ltd.). And a stainless-steel ball (SUS 304 ball) whose diameter is 10 mm was slid back and forth on the surface of the test specimen. The above surface nature test was conducted under the following conditions. The vertical load: 100 g, the friction speed: 600 mm/minute, the number of times in moving back and forth: 1800 times, the reciprocating stroke: 5 mm, the load converter capacity: 19.61 N, and the test specimen temperature: 40° C. Then whether or not any damage has been caused on the surface of the test specimen was observed and verified visually.

### Comparative Example

A composition for use in a comparative example is prepared using the same procedure and the condition as the exemplary embodiment excepting that the rod-like ionic liquid crystal compound was not added. And the thus obtained composition for the comparative example was coated on a test specimen and then a surface nature test was conducted to verify if there is any damage on the surface of the test specimen.

As a result, although no damage was found in the exemplary embodiment, damages were found on the surface of the test specimen in the comparative example. Therefore, it was verified that the inclusion of the rod-like ionic liquid crystal compound in the lubricant-layer-forming composition achieves the formation of a lubricant layer whose protection property is excellent.

What is claimed is:

1. A component for use in a bearing device, including a lubricant layer on a surface of the component, the lubricant layer containing a rod-like ionic liquid crystal compound having a cation group and an anion group.

2. A component, for use in a bearing device, according to claim 1, the bearing device including:
a shaft body;
a bearing body configured to house the shaft body in a relatively rotatable manner, the bearing body having an inner circumferential surface that surrounds circularly an outer circumferential surface of the shaft body via a gap;
a lubricant present in a gap between the outer circumferential surface and the inner circumferential surface; and
a radial dynamic pressure groove configured to generate a radial dynamic pressure in the lubricant, the radial dynamic pressure groove being provided on at least one of the outer circumferential surface and the inner circumferential surface,
wherein said component is at least one of the shaft body and the bearing body,
wherein, when said component is the shaft, the lubricant layer is provided on the outer circumferential surface thereof, and
wherein, when said component is the bearing body, the lubricant layer is provided on the inner circumferential surface thereof.

3. A component, for use in a bearing device, according to claim 1, wherein the cation group is a pyridinium group.

4. A component, for use in a bearing device, according to claim 1, wherein the rod-like ionic liquid crystal compound contains at least one of a first pyridinium salt type liquid crystal compound represented by a formula (1) and a second pyridinium salt type liquid crystal compound represented by a formula (2). 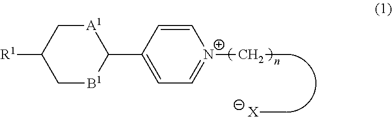
[In a formulas (1), R¹ is an alkyl group, an alkoxy group, or a group having an unsaturated bond represented by the following formula (3). A¹ and B¹ are each independently O, S, NH or CH₂. X⁻ is SO₃⁻, COO⁻, PO₃⁻, or PO₃²⁻. “n” is an integer greater than or equal to “0”.] 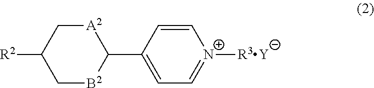
[In a formulas (2), R² and R³ are each independently an alkyl group, an alkoxy group, or a group having an unsaturated bond represented by the following formula (3). A² and B² are each independently O, S, NH or CH₂. Y⁻ is a halogen atom.] 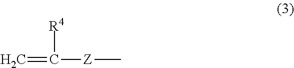
[In the formulas (3), R⁴ is H or CH₃, and Z is (CH₂)ₘ, (CH₂)ₘ—O, CO—O—(CH₂)ₘ, CO—O—(CH₂)ₘ—O, C₆H₄—CH₂—O, or CO. “m” is any one of integers 1 to 30.]

5. A component, for use in a bearing device, according to claim 4, wherein the lubricant layer contains a plurality of kinds of rod-like ionic liquid crystal compounds.

6. A component, for use in a bearing device, according to claim 1, wherein the rod-like ionic liquid crystal compound forms a vertical sequence in relation to a surface of said component.

7. A component, for use in a bearing device, according to claim 1, wherein the lubricant layer has a monomolecular layer of the rod-like ionic liquid crystal compound in at least a part of a region where the lubricant layer is in contact with a surface of said component.

8. A component, for use in a bearing device, according to claim 1, wherein the lubricant layer contains at least one of a non-ionic liquid crystal compound and a non-ionic lubricant.

9. A component for use in a bearing device, including a lubricant layer on a surface of the component, the lubricant layer containing a rod-like ionic liquid crystal compound having a cation group and an anion group,
the bearing device including:
a rotating body, having a rotary body surface, configured to extend vertically to a rotating axis;
a static body having a static body surface facing in axial opposition to the rotary body surface;
a lubricant present in a gap between the static body surface and the rotary body surface; and
a thrust dynamic pressure groove configured to generate a thrust dynamic pressure in the lubricant, the thrust dynamic pressure groove being provided in at least one of the static body surface and the rotary body surface,
wherein said component is at least one of the rotating body and the static body,
wherein, when said component is the rotating body, the lubricant layer is provided on the rotary body surface, and
wherein, when said component is the static body, the lubricant layer is provided on the static body surface.

10. A component, for use in a bearing device, according to claim 9, wherein the cation group is a pyridinium group.

11. A component, for use in a bearing device, according to claim 9, wherein the rod-like ionic liquid crystal compound contains at least one of a first pyridinium salt type liquid crystal compound represented by a formula (1) and a second pyridinium salt type liquid crystal compound represented by a formula (2). 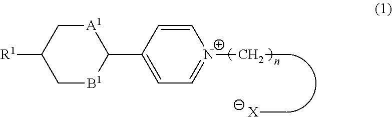
[In a formulas (1), R¹ is an alkyl group, an alkoxy group, or a group having an unsaturated bond represented by the following formula (3). A¹ and B¹ are each independently O, S, NH or CH₂. X⁻ is SO₃⁻, COO⁻, PO₃⁻, or PO₃²⁻. “n” is an integer greater than or equal to “0”.] 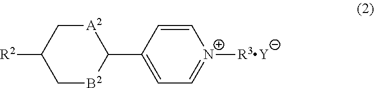
[In a formulas (2), R² and R³ are each independently an alkyl group, an alkoxy group, or a group having an unsaturated bond represented by the following formula (3). A² and B² are each independently O, S, NH or CH₂. Y⁻ is a halogen atom.] 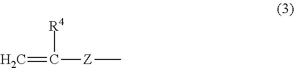
[In the formulas (3), R⁴ is H or CH₃, and Z is (CH₂)ₘ, (CH₂)ₘ—O, CO—O—(CH₂)ₘ, CO—O—(CH₂)ₘ—O, C₆H₄—CH₂—O, or CO. “m” is any one of integers 1 to 30.]

12. A component, for use in a bearing device, according to claim 11, wherein the lubricant layer contains a plurality of kinds of rod-like ionic liquid crystal compounds.

13. A component, for use in a bearing device, according to claim 9, wherein the rod-like ionic liquid crystal compound forms a vertical sequence in relation to a surface of said component.

14. A component, for use in a bearing device, according to claim 9, wherein the lubricant layer has a monomolecular layer of the rod-like ionic liquid crystal compound in at least a part of a region where the lubricant layer is in contact with a surface of said component.

15. A component, for use in a bearing device, according to claim 9, wherein the lubricant layer contains at least one of a non-ionic liquid crystal compound and a non-ionic lubricant.
